(19) United States
(12) Patent Application Publication
(10) Pub. No.: US 2009/0006242 A1
(43) Pub. Date: Jan. 1, 2009

(54) Automated auctioning method for market evaluation

(75) Inventors: Iqbal Adjali, Sharnbrook (GB); Malcolm Benjamin Dias, Sharnbrook (GB); Abhijit Sengupta, Sharnbrook (GB)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco Inc, d/b/a UNILEVER

(21) Appl. No.: 11/824,268

(22) Filed: Jun. 29, 2007

(51) Int. Cl. G06Q 30/00

(52) U.S. Cl. 705/37

(57) ABSTRACT

In an automatic auctioning method for determining market valuations, the auction process operates in two rounds, whereby the first round is a “sealed bid first price” auction while the second round is an “ascending price” auction. All bids and the winners of both rounds are kept confidential until the second round is completed. Data on bids made and consequential winning results are analysed and processed.

The present invention relates to an automatic auctioning method for determining market valuations, and a system and software for such determinations.

Auctions are an established selling mechanism with several advantages. They are well defined economic environments which are flexible enough for moderately easy integration into any kind of market. Behavioural rules for both buyers and sellers are pre-defined and hence the mechanism allows econometric and statistical analysis. In essence, auctions can be used as a basis for social and psychological experiments in the market without the shackles of a laboratory environment.

Auctions can be divided into two broad categories—the “sealed bid” and the “open bid” varieties. These can be further subdivided on the basis of the mechanistic and pricing rules. Economic literature predicts that each such variety will elicit a different kind of response from the bidders, which not only depends on how the auction is run, but also on the environment in which the auction is conducted.

There are four standard auction formats the “first price” sealed bid, the “second price” sealed bid, the ascending bid (also know as oral or English) and the descending bid (also known as the Dutch bid). In addition, there are a number of non-standard ones particular to the sale of specific items, but they can be either shown to be equivalent to one or more of the above or are irrelevant for the present analysis.

For simplicity, consider the sale of only one item to N≧2 bidders. The “first price sealed” bid variety is probably the simplest one to describe. Here, each bidder submits a bid without any knowledge of what the other bidders are submitting. The highest bidder wins the auction and pays the bid amount that he made.

The “second price sealed” bid one is conducted in the same manner, with the only difference arising in the amount that the winner pays. Here the winner pays, not the bid he submitted himself, but that of the second highest bidder. This form of bid is often called the Vickery auction.

The English auction is the more traditional one, in which an auctioneer starts at a very low price and keeps raising it at regular intervals. Bidders keep dropping off with increasing price and the auction ends when only one bidder remains. This last bidder is the winner and he pays the amount at which the last bidder dropped off.

The Dutch auction runs in the opposite direction. The auctioneer starts off at a very high price, at which presumably no bidder is willing to buy, and then gradually decreases it at a regular rate. The first bidder to accept the going price wins.

The present invention provides an automated auctioning method for determining market valuations and market demand for a product, comprising:
(i) presenting a first unit of the product to a sample of consumers in a first price sealed bid auction;
(ii) receiving sealed bids for the first unit from one or more of the consumers, each sealed bid including a maximum amount that the respective consumer is willing to bid;
(iii) determining which bid(s) corresponds to the highest bid and then determining the winner;
(iv) presenting a second unit of the product to the same sample of consumers;
(v) setting an initial price for the second unit, the initial price being the lowest possible, ensuring that all or most are willing to participate at that price;
(vi) receiving acknowledgements from one or more of the consumers as to whether they are willing to bid at that price;
(vii) modifying the price by a fixed amount in accordance with the acknowledgements received;
(viii) repeating steps (vi) to (vii) until only one consumer agrees to bid at the modified price;
(ix) identifying the consumer(s) who won the first unit and the second unit and announcing the winning bid amounts.

The method may include any one or more of the following features:
step (vi) comprises at least one consumer advising that they are willing to bid at the price, step (vii) comprises incrementing the price by a fixed amount.
the step of deriving an empirical distribution of prices based on the maximum amounts of the sealed bids.
the step of deriving an empirical distribution of valuations based on the incremental prices and number of acknowledgements received at the respective incremental prices.

According to the present invention, there is also provided a computer program product directly loadable into the internal memory of a digital computer, comprising software code portions for performing the method of the present invention when said product is run on a computer.

According to the present invention, there is also provided a computer program directly loadable into the internal memory of a digital computer, comprising software code portions for performing the method of the present invention when said program is run on a computer.

According to the present invention, there is also provided a carrier, which may comprise electronic signals, for a computer program embodying the present invention.

According to the present invention, there is also provided electronic distribution of a computer program product, or a computer program, or a carrier of the present invention.

According to the present invention, there is also provided an automated system for determining market valuations and market demand for a product, comprising:
a unit to receive sealed bids for a first unit of the product from one or more consumers, each sealed bid including a maximum amount that the respective consumer is willing to bid;
a module to determine which bid corresponds to the highest bid;
a module to set an initial price for a second unit of the product, the initial price being lower that an estimated market value;
a unit to receive acknowledgements from one or more of the consumers as to whether they are willing to bid at that price;
a module to modify the price by a fixed amount in accordance with the acknowledgements received until only one consumer agrees to bid at the modified price;
a unit to identify the consumer(s) who won the first unit and the second unit and announcing the winning bid amounts.

The present invention includes one or more aspects, embodiments and/or features of said aspects and/or embodiments in isolation and/or in various combinations whether or not specifically stated (including claimed) in that combination or in isolation.

### GENERAL DESCRIPTION OF THE PRESENT INVENTION

In order that the present invention may more readily be understood, a description is now given, by way of example only, reference being made to the accompanying drawings, in which:

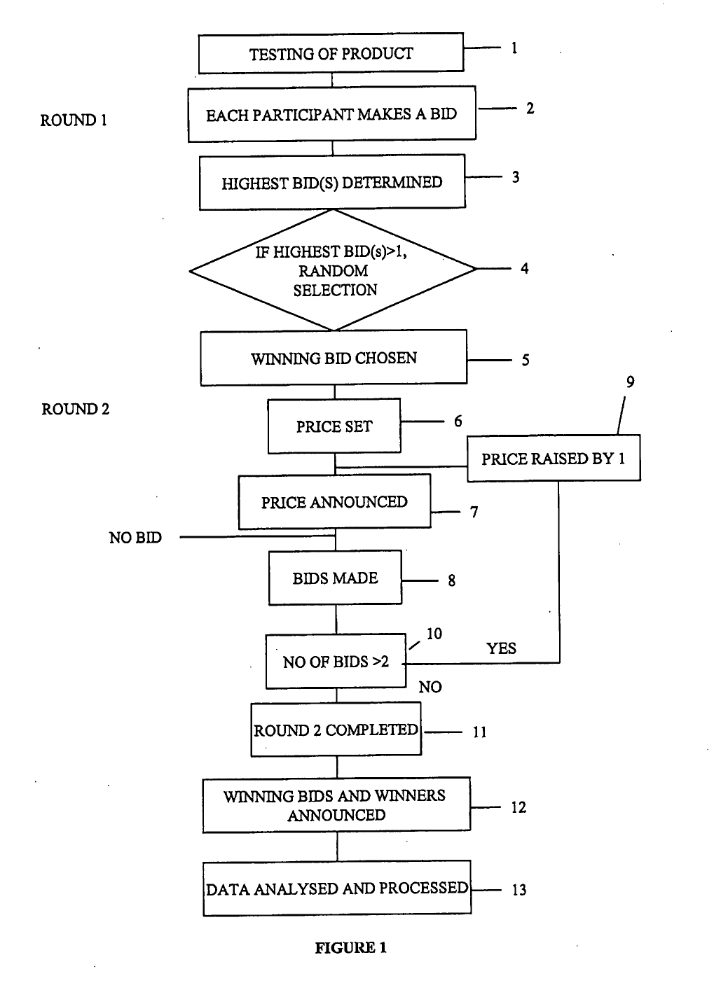

FIG. 1 is a flow diagram of a method embodying the present invention;

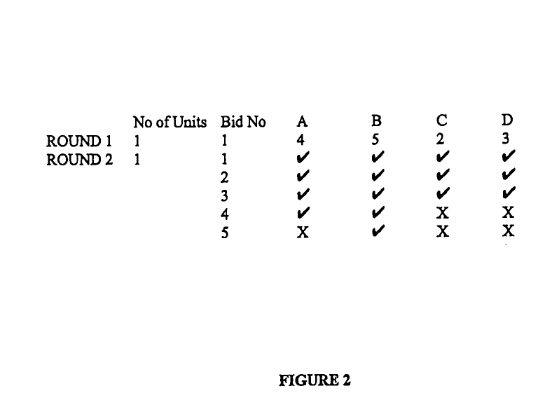

FIG. 2 is a schematic table of the bids made by a group of participants in the auction following the flow diagram of FIG. 1;

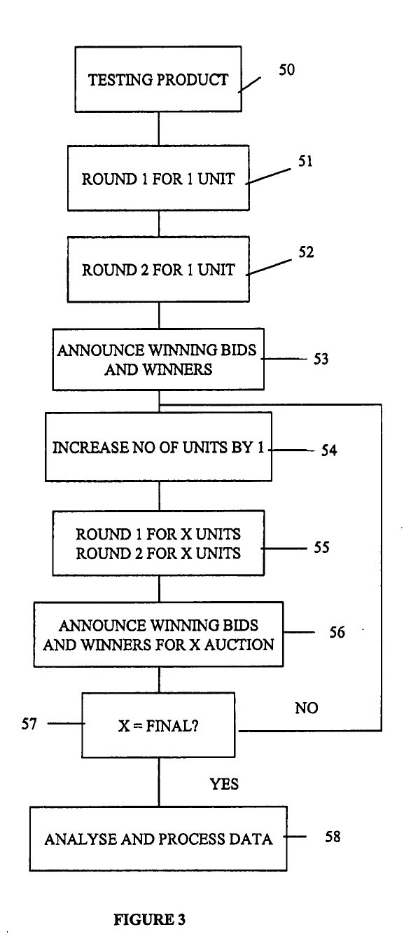

FIG. 3 is a flow diagram of a second embodiment of the present invention;

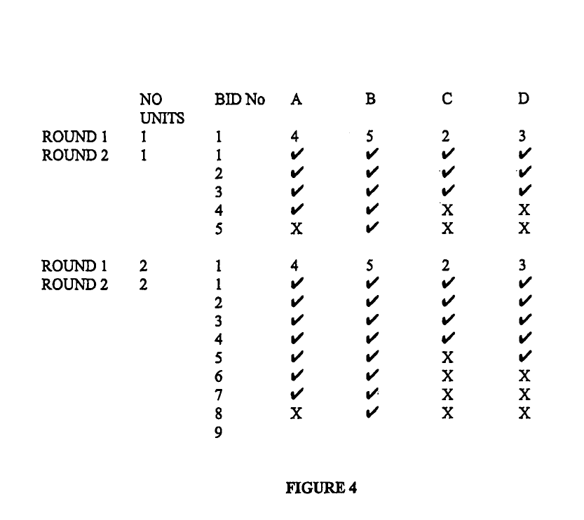

FIG. 4 is a schematic table of the bids for FIG. 3;

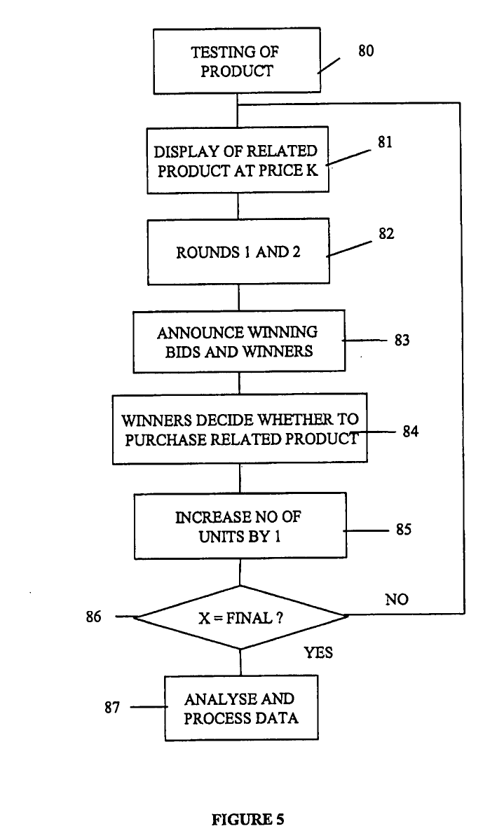

FIG. 5 is a flow diagram of a third embodiment of the present invention; and

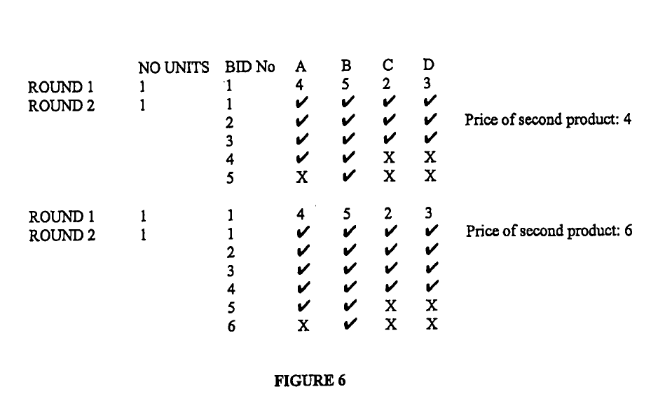

FIG. 6 is a schematic table for FIG. 5.

This auction experiment is conducted before the actual launch of the product, in order to mitigate external influences beyond the control of the auctioneer.

Consider a sample of N participants drawn from a population, P. Each participant is allowed the use (1) of this new product for some length of time. Once this trial period is over, they are required to participate in an auction carried out within a controlled environment.

The auction process itself operates in two rounds: the first round is a “sealed bid first price” auction, while the second is an “English” auction. Consider two units of the same product put up for sale, one for each part. There is one winner in each round. Also the two stages of auction are conducted anonymously, i.e. no participant is aware of how or what others are bidding.

In the first round, each participant submits (2) a sealed bid for the product—the maximum amount the participant is willing to pay for the product. The bids are collected and stored. The highest bidder wins (5) and pays the amount that he has bid. Any ties in winning bids are resolved (3, 4) by choosing one of the tied participants randomly. The bids which have been made, are not disclosed at this stage, likewise the successful bid and the winning participant; all are kept secret until the end of the second round.

In the second round, an ascending price English auction is carried out on the same group of participants when selling a second unit of the same product. In this case, a low initial price is set (6) and announced (7), after which the price is raised (9) at regular intervals by a fixed amount. The participants have a choice of either dropping out at the going price, or continuing (8) to the next discrete bid. If they drop out, they are no longer participants. It is crucial to ensure that the only information that bidders have at this point is the current price and not who the current bidders are or how many have dropped out. The second round of the auction stops (11) when the last but one drops out. The one survivor is the winner and pays the price at which the auction stopped. Once again, all data regarding who drops out and what price need to be stored. At this stage, winners of both rounds are announced (12), the items are presented to the winners and their bids are collected.

Thus consider that four people A, B, C, D make bids in the first round as shown in FIG. 2, namely A bids 4 units, and so on. Each person knows only his bid, and doesn't know whether it is successful or not when entering the second round.

Thus, in the second round, the participant A merely signals continuing the bidding for the first three bids (being 1 to 3), shown as “Y”, without having to make a conscious active decision whether to make a bid.

It is only when the bidding reaches “4 units”, is it necessary for A actively to decide whether he wants to bid at this amount; in this example, he then decides to continue the bidding, shown by “Y”.

At this point, although none of the participants are aware of the bidding situation, the actual situation is that C and D have stopped bidding, and A and B are the only ones still bidding.

Thus the 2^{nd} round continues, and the bidding increases to a price of 5 units. Again, each of A and B bid, so the round continues.

The bidding increases to a price of 6 units. At this point, A decides not to bid, but B continues to bid, meaning that there is a single bid remaining. So B is declared the winner of the second round at a price of 6 units.

In summary, B wins Round 1 at a price of 5 units, and B wins Round 2 at a price of 6 units.

With the conclusion of the two rounds, two sets of data are available for analysis and processing (13). The data from the first round reveals the sample distribution of bids or willingness to pay. The distribution is provided of bᵢ(vᵢ) where vᵢ is the monetary valuation of the object to bidder i for all i ε N. The second round reveals the sample distribution of vᵢ's. Two general patterns may be provided from the data. Firstly, bᵢ(vᵢ)≦vᵢ and second bᵢ(vᵢ) should be increasing in vᵢ, which help in running a consistency check on the data.

The first round provides an estimate what an individual is actually willing to pay while the second provides a monetary value of how much he values the product.

In addition to the estimation of population valuations and willingness to pay, it is possible to estimate the market demand curve from this data. Suppose one has fitted the distribution of willingness to pay for the whole population. Let this distribution be F(B) where B is a random variable representing willingness to pay. For a large population, F(x)=Pr[B<x] represents the proportion of the population with B<x.

Consider any price p>0. Then any individual randomly drawn from the population having a willingness to pay b, would buy this product if p≦b. Then the market demand at price p is given by D(p)=1−F(p). Since this can be carried out for any p>0, we can map out the whole demand curve as a function of price.

The described auctioning process of the present invention can be readily implemented in software operations by a person skilled in the art.

In another embodiment, described with reference to FIGS. 3 and 4, the auctions are run in multiple stages with each stage having the two rounds as before. Also, the quantity put up for sale is important. After testing a products (50), the first stage begins with the minimum possible amount of the product, for example the smallest pack size. Rounds 1 and 2, in similar fashion to the first embodiment, are conducted (51, 52) and the winning bids and winners are announced (53).

Then, at every subsequent stage, the amount is incremented by one unit, (54). Note, that every stage will have two winners as before as announced at 56—one from each round.

Now, if the smallest amount offered for sale is indexed as 1, and the largest indexed by S, the data generated is in the form of sample distributions of vᵢ(s) and bᵢ(s),for all s=1 . . . S. To construct the individual demands from the sample, once again consider any arbitrary price p>0. An individual i ε N, then has a demand given by,

Dᵢ(p)=s*εS where s*solves bᵢ(vᵢ(s*+1))<p≦bᵢ(vᵢ(s*)).

This can be constructed for any p and any I to produce the individual demand curves of everyone in the sample. Using these individual demands, one can arrive at the individual price elasticities.

A check is made at each increment in units, 57, until the final count is reached, whereupon the data is analysed and processed (58).

FIG. 4 shows a table of bids for the embodiment of the present invention described in relation to the flow diagram of FIG. 3.

In a further embodiment described with reference to FIGS. 5 and 6, the auction framework can be utilised to estimate the effect on a product as a result of changes in price of a related product (either a complement or a substitute). This embodiment differs from the previous one principally in that, after testing (80), and at the beginning of each stage, the participants are shown (81) a second product with a particular price K attached to it.

The two rounds of bidding (82) then start as described before, and the winning bids and winners of the rounds are announced (83). However, only the winners of that stage have the option of buying the second product at the end of each stage (instead of the auctioned product if substitutes, or together with the auctioned product if complements) at the pre-announced price K of that stage. Then the number of units are increased (85) by 1 for the next stage, with a related, compliment or substitute product displayed a price K₁ which may be the same, or more, or less as considered appropriate, and the procedure re-iterated until the final number of units is reached (86), whereupon the data is analysed and processed (87).

Thus, a major difference is that, in addition to or instead of varying the number of units being sold at every stage, the price of the second product is varied over a fixed range. Using the techniques described in the first example, multiple demand curves can be constructed, one for every stage in the auction. The separation of these demands curves may provide an estimate of the cross price elasticities with respect to the second product.

The embodiments described above have several advantages. They are relatively simple and easy for the participants. They do not involve complicated rules and hence the training involved for participants is minimal. They provide very extensive data, and the data collection itself is not complicated. Also, the above mechanisms can be modified very easily to suit additional requirements and aims.

Using these embodiments, two major problems listed earlier are avoided. Firstly, there is no chance of collusion amongst the participants, as all auctions are carried out anonymously. Secondly, complications arising from learning and adaptation from watching other participants is also ruled out.

One issue is the non-uniform budget constraints of individuals. The participants typically have different budgets for the same commodity. Accordingly, the bidding behaviour, is not symmetric and reflects these differences. It is difficult adjusting for this, due to lack of information about individual budgets.

A second issue arises in the case of the repeated auctions, as in the second and third example. In both cases, the same product is sold over and over again to the same set of people. This is clearly illogical. One way to solve this is to hold each stage after a certain interval of time, for example a week, using the same sample of participants for each stage (although, this might introduce an additional problem of inter-temporal changes in preferences). While the sample must be held fixed when estimating individual demand, its not necessary while estimating the cross price elasticities. So different samples could be used for different stages in the third case, with the caveat that the samples do not differ from each other significantly.

### EXAMPLES OF THE PRESENT INVENTION

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of feature solve any problems disclosed herein, and without limitation to the scope of the claims. The applicant indicates that aspects of the present invention may consist of any such individual feature or combination of features. In view of the foregoing description, it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognised that structures, and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and screw may not be structural equivalents in that a nail employs a cylindrical surface to secure wooden part together, whereas a screw employs a helical surface, in the environment of fastening wooden parts, a nail and a screw may be equivalent structures.

1. An automated auctioning method for determining market valuations and market demand for a product, comprising:
(i) presenting a first unit of the product to a sample of consumers in a first price sealed bid auction;
(ii) receiving sealed bids for the first unit from one or more of the consumers, each sealed bid including a maximum amount that the respective consumer is willing to bid;
(iii) determining which bid(s) correspond to the highest bid and then determining the winner;
(iv) presenting a second unit of the product to the same sample of consumers;
(v) setting an initial price for the second unit, the initial price being the lowest possible, ensuring that all or most are willing to participate at that price;
(vi) receiving acknowledgements from one or more of the consumers as to whether they are willing to bid at that price;
(vii) modifying the price by a fixed amount in accordance with the acknowledgements received;
(viii) repeating steps (vi) to (vii) until only one consumer agrees to bid at the modified price;
(ix) identifying the consumer(s) who won the first unit and the second unit and announcing the winning bid amounts.

2. The automated auctioning method of claim 1 wherein:
step (vi) comprises at least one consumer advising that they are willing to bid at the price, step (vii) comprises incrementing the price by a fixed amount.

3. The automated auctioning method of claim 1, further comprising the step of deriving an empirical distribution of prices based on the maximum amounts of the sealed bids.

4. The automated auctioning method of a claim 1, further comprising the step of deriving an empirical distribution of valuations based on the incremental prices and number of acknowledgements received at the respective incremental prices.

5. The automated auctioning method of a claim 1 wherein steps (i) to (ix) as appropriate are re-iterated but with a different amount of the first and/or second unit(s).

6. The automated auctioning method of claim 1 offering a consumer who wins a unit to purchase a second product at a price set before step (ii).

7. The automated auctioning method of claim 6 wherein the second product is displayed before step (ii).

8. The automated auctioning method of claim 6 wherein the second product is related to, complementary to or a substitute for, the product comprising the first and/or second units.

9. An automated auctioning system for determining market valuations and market demand for a product, comprising:
a unit to receive sealed bids for a first unit of the product from one or more consumers, each sealed bid including a maximum amount that the respective consumer is willing to bid;
a module to determine which bid corresponds to the highest bid;
a module to set an initial price for a second unit of the product, the initial price being lower that an estimated market value;
a unit to receive acknowledgements from one or more of the consumers as to whether they are willing to bid at that price;
a module to modify the price by a fixed amount in accordance with the acknowledgements received until only one consumer agrees to bid at the modified price;
a unit to identify the consumer(s) who won the first unit and the second unit and announcing the winning bid amounts.

10. The automated auctioning system of claim 9 comprising, when at least one consumer is willing to bid at the price, a module to increment the price by a fixed amount.

11. The automated auctioning system of claim 9 further comprising a unit to derive an empirical distribution of prices based on the maximum amounts of the sealed bids.

12. The automated auctioning system of claim 9 further comprising a module to derive an empirical distribution of valuations based on the incremental prices and number of acknowledgements received at the respective incremental prices.

13. The automated auctioning system of claim 9 wherein a module to re-iterate the operation but with a different amount of the first and/or second unit(s).
